(19) United States
(12) Patent Application Publication
(10) Pub. No.: US 2012/0258271 A1
(43) Pub. Date: Oct. 11, 2012

(54) METHODS FOR REDUCING TACK OF PRESSURE-SENSITIVE ADHESIVE

(75) Inventor: Weston Maughan, Lake Oswego, OR (US)

(73) Assignee: POINTIL SYSTEMS INC., Portland, OR (US)

(21) Appl. No.: 13/083,355

(22) Filed: Apr. 8, 2011

(51) Int. Cl. G09F 3/10; C09J 7/02; B05D 5/10

(52) U.S. Cl. 428/40.1; 427/256; 427/284

(57) ABSTRACT

The invention relates to labels and other items that have a surface at least partially coated with an adhesive. In various embodiments of the invention, an agent is applied to a region in the adhesive to reduce tackiness of the adhesive in the region. This may reduce the oozing of adhesive, particularly during storage, shipping and use of labels in various types of printers.

### FIELD OF INVENTION

The invention provides methods for reducing the tack of portions of pressure-sensitive adhesives in pressure-sensitive labels and other items, and various uses for the same.

### BACKGROUND OF THE INVENTION

A pressure sensitive label typically includes a release liner that has a silconized surface that is in contact with the backside (adhesive side) of the label (facestock). Pressure adhesive labels utilize pressure-sensitive adhesives (PSA) that form a bond between the label and the surface to which the label is adhered when pressure is applied. Pressure-sensitive adhesives do not solidify but instead remain viscous. The strength of the bond formed is influenced by the type of adhesive used (i.e. permanent, removable, etc.) and amount of pressure applied. Pressure-sensitive adhesives are used in, among many other things, pressure sensitive labels, tapes, note pads and automobile trims. Pressure sensitive adhesives are available to work within a range of environments including freezer or refrigerator temperatures to high heat temperatures and/or low humidity to high humidity ranges. Typically adhesives become softer at higher temperatures and/or high humidity. Adhesives designed for freezer or refrigerator applications will be softer at room temperature or higher. Adhesives designed for normal room temperature applications may be softer at elevated room temperature (i.e. normal adhesives used in laser printers utilizing high heat to melt toner onto the paper in the form of text or images). In every case, adhesives will soften as temperatures increase.

In practice, the pressure-sensitive adhesive is pre-applied and is sandwiched between the facestock of the label and the siliconized side of the protective liner (FIG. 1). This is most commonly manufactured by suppliers such as Fasson, Mactac, UPM Raflatac, Technicote and others, as raw material rolls of pre-constructed laminate to label converters. Due to the viscous nature of the pressure-sensitive adhesives, pressure-sensitive labels which use these adhesives are considered “soft” or susceptible to “spreading” out (i.e. oozing) when pressure is applied or when subject to heat. It is well known in the industry that 1) rubber based adhesives, especially those with heavier coat weight, are prone to oozing; and 2) freezer grade and/or all temperature adhesives which arc designed to work at cold temperatures, typically can have oozing problems at higher temperatures, especially when they arc a heavier than normal coat weight. Even regular/standard acrylic adhesive used in high temperature environments like laser printers, can result in an oozing problem. Non-ooze adhesive may be obtained from suppliers such as Mactac, to address this problem, though their ooze guarantee is limited.

When the adhesive oozes out, it typically forms a halo around the facestock shape or oozes between slits in the facestock and/or liner. Such oozing is evidenced on the side of raw material rolls of pressure sensitive label material supplied by the likes of Fasson, Mactac, UPM Raflatac, Technicote, and others to label converters prior to label conversion. If such labels are sheets in stacks, the adhesive that has oozed out around the die-cut shape on the front may stick to the surface above it (i.e., to the label in the stack above it), causing the label to pre-release from the liner (backer). If the labels are cut on the liner (i.e. the backside of the sandwich, FIG. 1), the oozing adhesive may stick to the surface below it (i.e., to the label in the stack below it). When this occurs the labels will stick together. If the labels are fan-folded, the adhesive may stick to the fold it is facing and prerelease when the folds are unfolded. If the labels are in rolls, the adhesive may stick to the wrap of labels above it if the ooze is on the face of the label material around the die cut pattern in the rolls and pre-released when the roll is unwound. In some label applications, holes are cut through both the facestock and liner at the same location, resulting in ooze exposure to both the top and bottom of the label. Such labels that run through printers (i.e.

thermal transfer printers, direct thermal printers, ink jet printers, laser printers, dot matrix and/or line printers) can induce mechanical problems when the adhesive oozes.

Further, label substrate is often made with a “heavy coat weight” of adhesive for difficult-to-adhere applications. As described above, these tend to be soft adhesives (for example, rubber based adhesives, all temperature/freezer grade adhesives and some acrylics). The heavier coat weight of adhesive adds to the potential for oozing.

Oozing may also result from rewinding labels into finished size rolls too tightly. Typically this may be seen on the labels near the core, where the tension/pressure is greater. This may also occur when users store their labels in less than recommended storage conditions (for example, stored labels in much higher temperature areas). The heat will soften the adhesive and cause oozing.

Other challenges presented by pressure-sensitive adhesives in a variety of contexts will be readily apparent to those of skill in the art.

Typically, laser printable labels are sheeted. If the adhesive has oozed out around the die cut area on the facestock, labels on the second sheet in the stack could prematurely release when stuck to the back of the first sheet. As the first sheet is advanced along the feed path, the pre-released label stuck to the back will stick to the first available surface in the feed path resulting in a paper jam resulting in printer stoppage and possible printer damage. Similarly, adhesive ooze can occur through slits on the backside of the liner resulting in adhesive exposure on the liner side. In such cases, the adhesive ooze from the back of the top sheet in a stack can stick to the next sheet in the stack. When the top sheet is advanced in the printer, the exposed adhesive may pull a label off the facestock of the next sheet in the stack, resulting in exposed adhesive.

Adhesive that comes in contact with hot fuser rollers in laser printers can permanently damage the fuser roller resulting in costly parts replacement and printer down time. Adhesive “debris” that is left along the feed path of the label through a printer can leave an adhesive path throughout the printer causing feeding problems such as jamming. Such adhesive debris can build up and eventually be pulled along the printer path by the label or documents being fed through for printing. Such issues may occur with every type of printer that may be used for printing labels, such as thermal transfer printers, direct thermal printers, ink jet printers, laser printers, dot matrix and/or line printers.

Adhesive ooze debris that ends up on the surface of the facestock may also impact the quality of the print image made by the printer.

Thermal and thermal transfer printers typically process roll labels or fanfold labels. If adhesive ooze is significant, labels may pre-dispense in the unwind process, exposing the entire adhesive area resulting in labels sticking to the first available surface in the feed path. This will cause a paper jam resulting in printer stoppage. If the adhesive ooze does not result in a pre-dispensed label, the label could proceed through the feed path and come in contact with the hot surface of the print-head resulting in print-head damage.

Accordingly, there is a need in the art for techniques to address the aforementioned and other limitations of pressure-sensitive adhesives so as to prevent undesired/unintended sticking.

### SUMMARY OF THE INVENTION

The invention is directed to methods for reducing the tack of an adhesive on a pressure-sensitive substrate, specifically at areas where adhesive may ooze from the sides of the laminates or from slits and/or die cuts made to the facestock or liner of the laminate. The method comprises providing a pressure-sensitive substrate comprising a side at least partially coated with the adhesive and applying an agent to a region in the adhesive, wherein the agent substantially reduces the tack of the adhesive in the region.

The invention further provides methods for making a pressure-sensitive label conducive to thermal printers, thermal transfer printers, laser printers, or other printing devices in which ooze creates a problem in the printing process. The method comprises providing a pressure-sensitive label comprising a side at least partially coated with an adhesive and applying an agent to a region in the adhesive, wherein the agent substantially reduces the tack of the adhesive in the region.

The invention also provides an article, comprising a label, comprising a facestock with a surface at least partially coated with an adhesive; and a liner to which the label is adhered, wherein the surface at least partially coated with the adhesive comprises a region to which an agent has been applied, reducing the tack of the adhesive in the region.

### BRIEF DESCRIPTION OF DRAWINGS

Exemplary embodiments are illustrated in referenced figures. It is intended that the embodiments and figures disclosed herein are to be considered illustrative rather than restrictive.

FIG. 1 (prior art): FIG. 1a depicts a die-cut label adhered to a liner, in accordance with an embodiment of the present invention. FIG. 1b depicts the label peeled back to expose the adhesive. FIG. 1c depicts the label with ooze around the die pattern in accordance with an embodiment of the present invention.

FIG. 2 depicts the side of a label coated with an adhesive and a deadening agent applied in a region along the edge of the adhesive, in accordance with an embodiment of the present invention.

FIG. 3: FIG. 3a depicts labels adhered to a liner with a face-slit between two labels in accordance with an embodiment of the present invention. FIG. 3b depicts the back of the liner showing the liner-slit between two labels in accordance with an embodiment of the present invention.

FIG. 4 depicts multiple labels adhered to the liner with face-slits between the labels in accordance with an embodiment of the present invention.

FIG. 5 depicts the process of printing-on the deadening agent in a specific pattern that would align with the die-cut pattern.

### DETAILED DESCRIPTION OF THE INVENTION

One skilled in the art will recognize many methods and materials similar or equivalent to those described herein, which could be used in the practice of the present invention. Indeed, the present invention is in no way limited to the methods and materials described. For purposes of the present invention, the following terms are defined below. Unless otherwise noted, terms are to be understood according to conventional usage by those of ordinary skill in the relevant art.

In the drawings, the size of the label and the thickness of the layers is not to scale and has been exaggerated for the purpose of clarity and illustration.

As used here, an “adhesive” is any material which will usefully hold two or more objects together solely by intimate surface contact. Examples of adhesives that may be used in connection with various embodiments of the invention include acrylic adhesives, solvent acrylic adhesives, emulsion acrylic adhesives, UV adhesives, and rubber/latex adhesives in the form of permanent or removable affixing. Rubber/latex adhesives and all temperature/freezer grade permanent adhesives are particularly sensitive to heat and pressure.

As used herein, a “label stock” refers to pressure-sensitive materials, which are usually printed, frequently die-cut, furnished in roll, fanfold, or sheet form with a liner, and intended for use as labels.

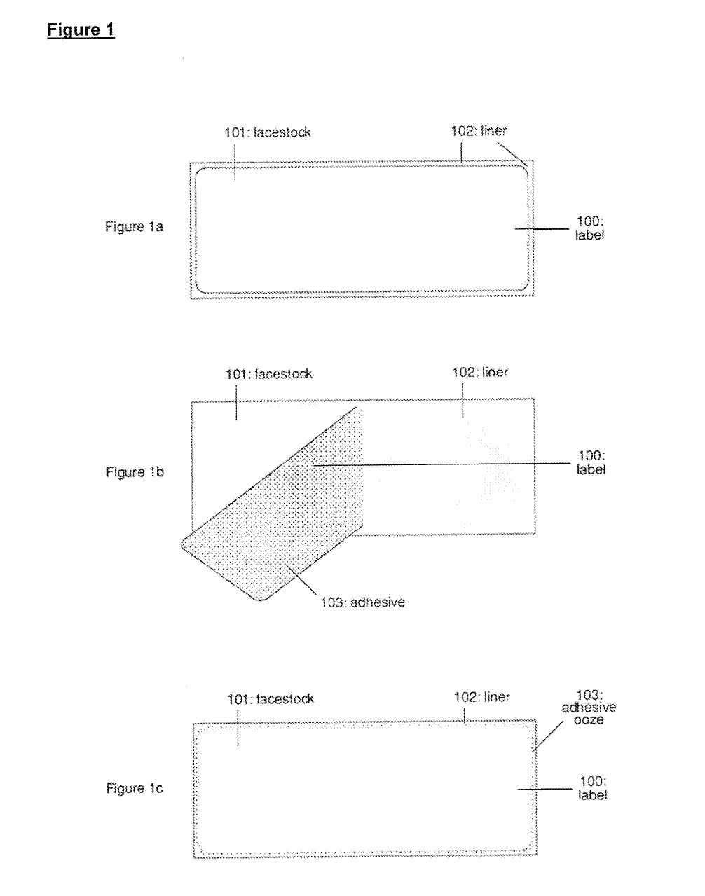

As used herein, a “liner” refers to the siliconized (waxy) release paper behind the adhesive (FIG. 1).

As used herein, a “multiple component adhesive” is a pressure sensitive adhesive containing one or more elastomers combined with resins and other components, which impart tack, adhesion, and other necessary properties.

As used herein, “oozing” refers to “squeezing out” of the adhesive from: between the liner and facestock, either around the circumference of the shape, through die cuts in the facestock, or through die cuts in the liner.

As used herein, “pressure-sensitive” adhesive (PSA) is used to designate a distinct category of adhesives which are tacky at room temperature and firmly adhere to a variety of dissimilar surfaces upon mere contact without the need of more than finger or hand pressure. PSAs require no activation by water, solvent or heat in order to exert a strong adhesive holding force toward such materials as paper, plastic, glass, wood, cement and metals. PSAs have a sufficiently cohesive holding and elastic nature so that, despite their tackiness, they can be handled with the fingers and removed from smooth surfaces without leaving a residue.

As used herein, “tack” is the condition of the adhesive when it is sticky and/or adhesive.

As used herein, “deadening agent” is an agent which reduces the tack of an adhesive. The deadening agent may cover the adhesive over an area exposed at or near an edge and/or die cut. Conversely, an “agent” that reduced tack of an adhesive is a deadening agent. Deadening agent may work at any location on the adhesive. The deadening agent may be clear/colorless or tinted/colored/pigmented with color so as to identify the deaden area visually. In one embodiment, a pigment is added to the clear deadening agent without affecting the tack-reducing property of the deadening agent. The degree of deadening may range from complete elimination of adhesive tack to only a moderate elimination of adhesive tack depending upon the requirements of the specific label application. Example of the deadening agent include but are not limited to Super Adhesive Deadener WLL009275, which is effective with both acrylic and rubber adhesive systems, and is available from Actega Wit Inc., Lincolnton, N.C. and UV Gloss Coating (product code KCG00279R) available from Sun Chemical.

The invention provides methods for reducing tack of pressure-sensitive adhesives, such as those used in pressure-sensitive labels. A pressure-sensitive label 100 bound to a liner 102 is illustrated in FIG. 1. The label 100 includes facestock 101 to which an adhesive surface 103 is applied. The adhesive surface 103 is protected from exposure by the liner 102.

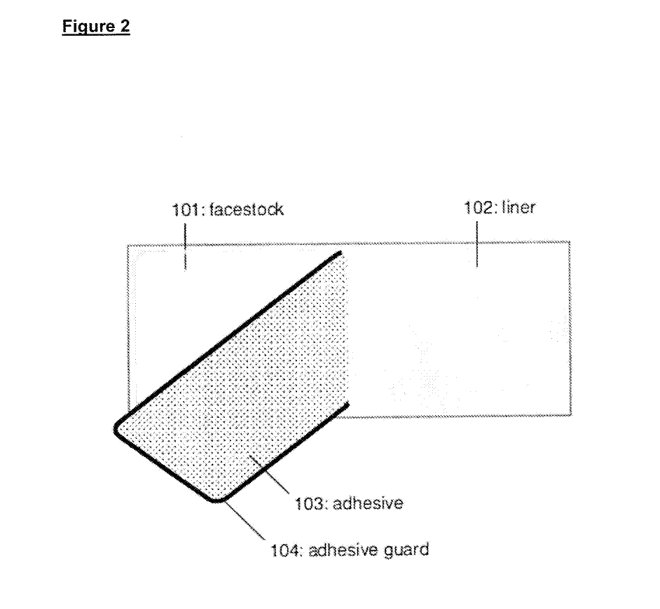

The inventive method includes applying an agent to the adhesive layer 103 in a region 104 to reduce tack of the adhesive layer 103 in the region 104. The region 104 may be configured such that oozing is reduced as compared with similar labels that have not been treated with an agent in accordance with the methods of the invention. In an embodiment of the invention, the tack of the adhesive is reduced in areas where adhesive ooze is possible by using a deadening agent in such areas. Areas where adhesive ooze is possible include but are not limited to die cut/slit areas. In another embodiment of the invention, the region 104 comprising the agent that reduces the tack of the adhesive is located around individual labels as shown in FIG. 2. In one embodiment, the agent is the deadening agent, Super Adhesive Deadener WLL009275 obtained from Actega Wit Inc., Lincolnton, N.C.. In another embodiment, the deadening agent is UV Gloss Coating (product code KCG00279R) available from Sun Chemical.

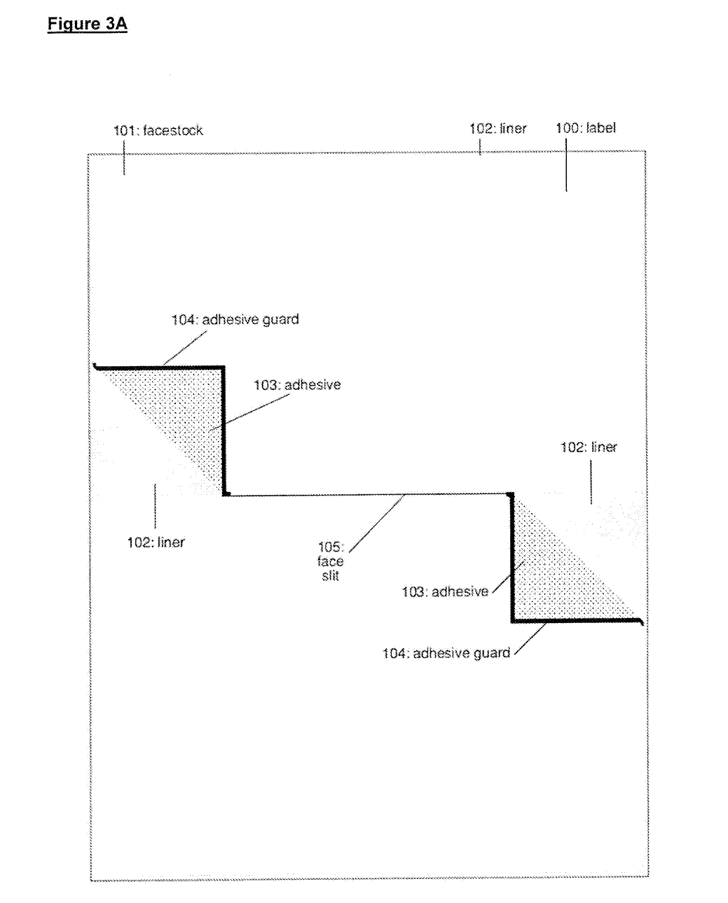

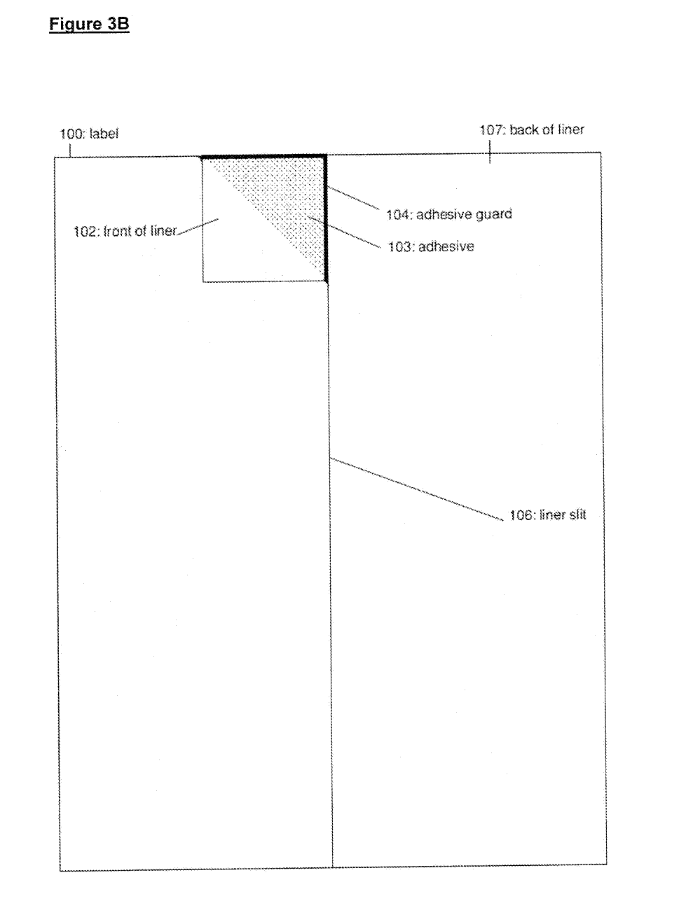

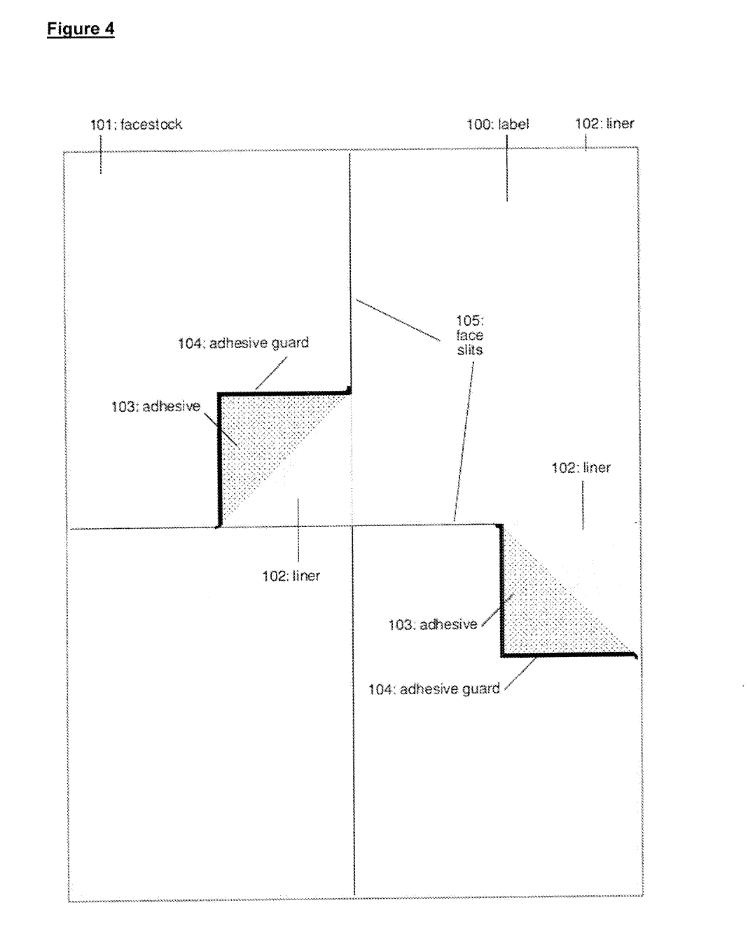

In a further embodiment of the invention, the region 104 comprising the agent that reduces the tack of the adhesive is located around the edges of multiple labels within a sheet (FIGS. 3a and 4) to reduce tack at the face slits 105 and to protect the face stock 101. In one embodiment, the agent is the deadening agent, Super Adhesive Deadener WLL009275 obtained from Actega Wit Inc., Lincolnton, N.C. In another embodiment, the deadening agent is UV Gloss Coating (product code KCG00279R) available from Sun Chemical.

In an additional embodiment of the invention, the region 104 comprising the agent that reduces the tack of the adhesive is located around the edges of multiple labels within a sheet (FIG. 3b) to reduce tack at the liner slit 106 and to protect the back of the liner 107. In one embodiment, the agent is the deadening agent, Super Adhesive Deadener WLL009275 obtained from Actega Wit Inc., Lincolnton, N.C. In another embodiment, the deadening agent is UV Gloss Coating (product code KCG00279R) available from Sun Chemical.

Pressure-sensitive labels with a deadening agent are made by applying a deadening agent in a pattern that would align with exposed edges (for example, the circumference of the die cut shape and/or any internal slits on the facestock or liner). Exposed edges may be simply on the edge of the material and/or any and all die cuts made to the facestock or liner.

Methods for applying the pressure-sensitive adhesive and the deadening agent are known to one skilled in the art. In one embodiment, the method comprises using available pressure sensitive materials from sources including but not limited to Fasson, Mactac, UPM Raflatac, Technicote, Flexcon and 3M. These materials are provided in a pre-constructed laminate sandwich that includes a facestock 101 and liner (backer) 102 with an adhesive 103 sandwiched in between the two. Such stocks could include paper thermal transfer label material (e.g. UPM Raflactac product #TT50F), paper laser label material (e.g. Fasson product #18884), paper EDP material (Mactac product # EDX2612), or film thermal transfer material (e.g. Mactac product # TLN2510-G).

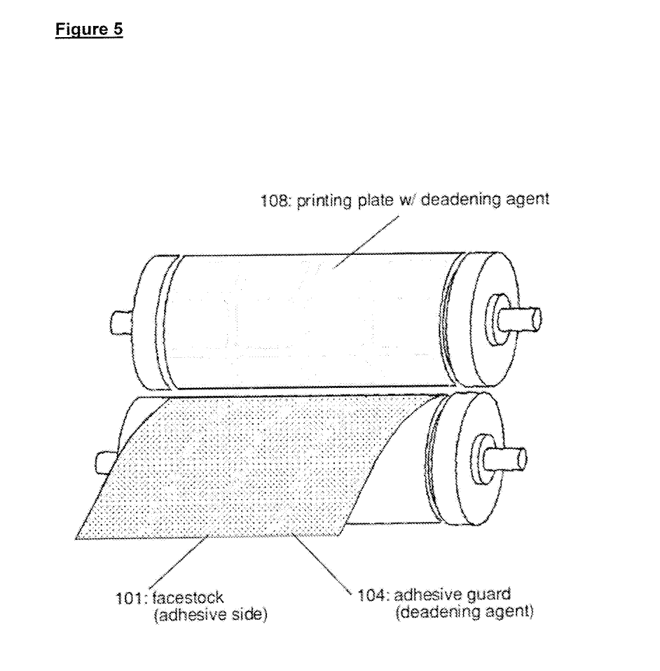

This method involves de-laminating the construction to expose the adhesive side of the label facestock. Once exposed, a printed pattern of deadening agent may be printed in a pattern that would align with exposed edges of the finished product (FIG. 5). Exposed edges may be simply the edge of the material and/or any and all die cuts made to the facestock and/or liner. The printing may be done in flexography, screen printing, offset, or UV printing processes. This may be done with conventional water based deadening agents, solvent based deadening agents, or UV cured deadening agents. Such agents may include Actega WIT Super Adhesive Deadener product code WLL009275 or Sun Chemical UV Gloss Coating product code KCG00279R. After the deadening agent is printed on the adhesive, the laminate is reconstructed. Once reconstructed additional text and graphic printing may be done on the face of the label and/or the back of the liner as is necessary for each unique label printing order. Die cutting can be made to the label facestock and/or liner. The die cutting would be made in such a way as to align with the printed pattern of deadening agent applied so as to create a barrier at any or all exposed edges as needed for the specific label application.

In another embodiment, the method of application of the pressure-sensitive adhesive and the deadening agent including using separately available components (i.e. facestock material, liner material, and adhesive material) and constructing the laminate during label production. In this method, the adhesive may be applied across the entire back of the single web of label facestock material. Then, the adhesive may be selectively deadened as described above, after which a single web of liner may be laid upon the adhesive, thus creating a pressure sensitive laminate. Similarly, adhesive may be applied across the entire face of a siliconized side of the liner, then the adhesive may be selectively deadened as described above, after which a single web of label facestock material may be laid upon the adhesive, thus creating a pressure sensitive laminate.

In one embodiment, the deadening agent 104 is applied heavy with at least a 1.0-2.0 bcm anilox, 2.0-3.0 bcm anilox, 3.0-4.0 bcm anilox, 4.0-5.0 bcm anilox, 5.0-6.0 bcm anilox, 6.0-7.0 bcm anilox, 7.0-8.0 bcm anilox, 8.0-9.0 bcm anilox or 9.0-10.0 bcm anilox. In a preferred embodiment, the deadening agent is applied heavy with at least a 6.0 bcm anilox.

In an embodiment of the invention, the region 104 is located at a distance from the edge or circumference of the adhesive layer 103, such as, for example, about 0.01 mm, 0.02 mm, 0.03 mm, 0.04 mm, 0.05 mm, 0.06 mm, 0.07 mm, 0.08 mm, 0.09 mm, 1.0 mm, 2.0 mm, 3.0 mm, 4.0 mm or 5.0 mm or more from the edge of the adhesive layer 103. In another embodiment of the invention (FIGS. 2), the region 104 is of a shape substantially similar to the perimeter of the label 100. In another embodiment of the invention, the region 104 is of a shape dissimilar to that of the perimeter of the label 100.

The region 104 may be of any desirable thickness, based on a variety of factors as will be apparent to those of skill in the art. Simply by way of example, the region may be of a thickness of about 0.01 mm, 0.02 mm, 0.03 mm, 0.04 mm, 0.05 mm, 0.06 mm, 0.07 mm, 0.08 mm, 0.09 mm, 1.0 mm, 2.0 mm, 3.0 mm, 4.0 mm, 5.0 mm, 6.0 mm, 7.0 mm, 8.0 mm, 9.0 mm or 10.0 mm or more.

In one embodiment, the pressure-sensitive adhesive comprises an elastomer and a tackifier. The elastomer may be based on acrylics, butyl rubber, ethylene-vinyl acetate (EVA), natural rubber, Nitrile, silicone rubbers, styrene block copolymers or vinyl ethers in addition to other elastomers that will be readily apparent to those of skill in the art. In another embodiment, adhesives that may be available in label material products include but are not limited to acrylic, acrylic emulsion, solvent acrylic, hot melt rubber, solvent rubber and UV acrylic. The tackifier may be a resin such as a rosin or derivate thereof, a terpenes, a modified terpene, an aliphatic resin, a cycloaliphatic resin, an aromatic resin, a hydrogenated hydrocarbon resin, a terpene-phenol resin, as well as mixtures thereof in addition to other tackifiers that will be readily apparent to those of skill in the art.

As those of skill in the art will readily appreciate, the methods of the invention have application in a wide variety of labels. Simply by way of example, the techniques of the invention can be used with, for example, labels, pressure-sensitive tapes and note pads.

A number of label applications require very tacky/aggressive adhesive. For example, such applications may include applying labels to solid flat rough surfaces such as unfinished wood; dimpled or curved surfaces such as tires; irregularly shaped surfaces such as slotted cartons; areas in which labels wrap around a corner such as a carton corner; wax covered areas such as wax sided cartons; and cold temperatures environments in which labels are applied such as cold storage warehouses, or produce coolers. Conversely, there may be very slick surfaces that require aggressive adhesive in order to adhere to such surfaces.

Many such labels are used to identify (potentially uniquely) the items to which they are attached (e.g. cartons, pallets, individual items such as tires, etc.). Most commonly, unique information is generated via printers such as thermal transfer printers, direct thermal printers, ink jet printers, dot matrix printers, line printers, and/or laser printers. Some printers (i.e. laser printers) generate enough heat that can cause adhesives with a moderate level of tack to soften, creating ooze.

Users that print labels requiring aggressive adhesive via such printing devices are confronted with a choice of reducing adhesive tack to prevent adhesive ooze in their printer, thus compromising their label application, or confronting the problem of adhesive ooze within their printer resulting in printer jams and potential printer damage. Few label manufacturers can “zone” coat adhesive (creating patterns where there is adhesive and areas without adhesive), but this is typically limited to hot melt rubber based adhesives, thus limiting the choice of adhesive for the desired application.

The methods of the invention may further be used to make pressure-sensitive labels conducive for laser printers or for thermal and thermal transfer printers.

In an embodiment, the invention includes a label 100 or quantity of labels 100 that include a region 104 as described above.

The various methods and techniques described above provide a number of ways to carry out the invention. Of course, it is to be understood that not necessarily all objectives or advantages described may be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as may be taught or suggested herein. A variety of advantageous and disadvantageous alternatives are mentioned herein. It is to be understood that some preferred embodiments specifically include one, another, or several advantageous features, while others specifically exclude one, another, or several disadvantageous features, while still others specifically mitigate a present disadvantageous feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be mixed and matched by one of ordinary skill in this art to perform methods in accordance with principles described herein. Among the various elements, features, and steps some will be specifically included and others specifically excluded in diverse embodiments.

Although the invention has been disclosed in the context of certain embodiments and examples, it will be understood by those skilled in the art that the embodiments of the invention extend beyond the specifically disclosed embodiments to other alternative embodiments and/or uses and modifications and equivalents thereof.

Many variations and alternative elements have been disclosed in embodiments of the present invention. Still further variations and alternate elements will be apparent to one of skill in the art. Among these variations, without limitation, are the types of adhesives utilized, the configuration of the surface upon which an agent is applied to reduce tack, and the particular use of the labels modified through the teachings of the invention. Various embodiments of the invention can specifically include or exclude any of these variations or elements.

In some embodiments, the numbers expressing quantities of ingredients, properties such as viscosity, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

In some embodiments, the terms “a” and “an” and “the” and similar references used in the context of describing a particular embodiment of the invention (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Preferred embodiments of this invention are described herein, including the best mode known to the inventors for carrying out the invention. Variations on those preferred embodiments will become apparent to those of ordinary skill in the art upon reading the foregoing description. It is contemplated that skilled artisans can employ such variations as appropriate, and the invention can be practiced otherwise than specifically described herein. Accordingly, many embodiments of this invention include all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents and printed publications throughout this specification. Each of the above cited references and printed publications are herein individually incorporated by reference in their entirety.

In closing, it is to be understood that the embodiments of the invention disclosed herein are illustrative of the principles of the present invention. Other modifications that can be employed can be within the scope of the invention. Thus, by way of example, but not of limitation, alternative configurations of the present invention can be utilized in accordance with the teachings herein. Accordingly, embodiments of the present invention are not limited to that precisely as shown and described.

What is claimed is:

1. A method for reducing the tack of an adhesive on a pressure-sensitive substrate comprising:
providing a pressure-sensitive substrate comprising a side at least partially coated with the adhesive; and
applying an agent to a region in the adhesive, wherein the agent substantially reduces the tack of the adhesive in the region and is configured to reduce the likelihood of the adhesive oozing.

2. The method of claim 1, wherein the substrate is a label.

3. The method of claim 1, wherein the substrate is selected from the group consisting of tapes and note pads.

4. The method of claim 1, wherein the adhesive is a pressure-sensitive adhesive.

5. The method of claim 4, wherein the pressure-sensitive adhesive is selected from the group consisting of acrylics, butyl rubber, ethylene-vinyl acetate, natural rubber, Nitrile, silicone rubbers, styrene block copolymers, vinyl ethers, resins, rosins, terpenes, modified terpenes, aliphatic resins, cycloaliphatic resins, aromatic resins, hydrogenated hydrocarbon resins, terpene-phenol resins, and combinations thereof.

6. The method of claim 1, wherein the side at least partially coated with the adhesive is entirely coated with the adhesive.

7. The method of claim 1, wherein the agent is a deadening agent.

8. The method of claim 8, wherein the deadening agent is Super Adhesive Deadener W11009275 or UV Gloss Coating KCG00279R.

9. The method of claim 1, wherein the region is located at or adjacent to the edge of the side at least partially coated with the adhesive.

10. The method of claim 1, wherein the region is located at a distance from the edge of the side at least partially coated with the adhesive.

11. The method of claim 1, wherein the region is of a shape substantially similar to the perimeter of the side of the substrate at least partially coated with the adhesive.

12. The method of claim 1, wherein the region is of a shape dissimilar to the perimeter of the side of the substrate at least partially coated with the adhesive.

13. A method for making a pressure-sensitive label conducive to thermal printers, thermal transfer printers or laser printers, comprising
providing a pressure-sensitive label comprising a side at least partially coated with an adhesive; and
applying an agent to a region in the adhesive, wherein the agent substantially reduces the tack of the adhesive in the region.

14. The method of claim 13, wherein the pressure-sensitive adhesive is selected from the group consisting of acrylics, butyl rubber, ethylene-vinyl acetate, natural rubber, Nitrile, silicone rubbers, styrene block copolymers, vinyl ethers, resins, rosins, terpenes, modified terpenes, aliphatic resins, cycloaliphatic resins, aromatic resins, hydrogenated hydrocarbon resins, terpene-phenol resins, and combinations thereof.

15. The method of claim 13, wherein the side at least partially coated with the adhesive is entirely coated with the adhesive.

16. The method of claim 13, wherein the agent is a deadening agent.

17. The method of claim 16, wherein the deadening agent is Super Adhesive Deadener WLL009275

18. The method of claim 13, wherein the region is located at or adjacent to the edge of the side at least partially coated with the adhesive.

19. The method of claim 13, wherein the region is located at a distance from the edge of the side at least partially coated with the adhesive.

20. The method of claim 13, wherein the region is of a shape substantially similar to the perimeter of the side of the label at least partially coated with the adhesive.

21. The method of claim 13, wherein the region is of a shape dissimilar to the perimeter of the side of the label at least partially coated with the adhesive.

22. An article, comprising:
a label, comprising a facestock with a surface at least partially coated with an adhesive; and
a liner to which the label is adhered,
wherein the surface at least partially coated with the adhesive comprises a region to which an agent has been applied, reducing the tack of the adhesive in the region and configured to reduce the likelihood of the adhesive oozing.

23. The article of claim 22, wherein the adhesive is a pressure-sensitive adhesive.

24. The article of claim 23, wherein the pressure-sensitive adhesive is selected from the group consisting of acrylics, butyl rubber, ethylene-vinyl acetate, natural rubber, Nitrile, silicone rubbers, styrene block copolymers, vinyl ethers, resins, rosins, terpenes, modified terpenes, aliphatic resins, cycloaliphatic resins, aromatic resins, hydrogenated hydrocarbon resins, terpene-phenol resins, and combinations thereof.

25. The article of claim 22, wherein the surface at least partially coated with the adhesive is entirely coated with the adhesive.

26. The article of claim 22, wherein the agent is Super Adhesive Deadener WLL009275.

27. The article of claim 22, wherein the region is located at or adjacent to the edge of the surface at least partially coated with the adhesive.

28. The article of claim 22, wherein the region is located at a distance from the edge of the surface at least partially coated with the adhesive.

29. The article of claim 22, wherein the region is of a shape substantially similar to the perimeter of the surface of the label at least partially coated with the adhesive.

30. The article of claim 22, wherein the region is of a shape dissimilar to the perimeter of the surface of the label at least partially coated with the adhesive.
